(19) United States
(12) Patent Application Publication
(10) Pub. No.: US 2016/0252766 A1
(43) Pub. Date: Sep. 1, 2016

(54) COLOR FILM SUBSTRATE, METHOD FOR FABRICATING THE SAME TOUCH DISPLAY DEVICE

(71) Applicants: BOE TECHNOLOGY GROUP CO., LTD., Beijing (CN); HEFEI XINSHENG OPTOELETRONICS TECHNOLOGY CO., LTD., Hesei, Anhui (CN)

(72) Inventors: Guodong Liu, Beijing (CN); Ming Hu, Beijing (CN)

(21) Appl. No.: 14/767,631

(22) PCT Filed: Dec. 1, 2014
(86) PCT No.: PCT/CN14/92662

§ 371 Date: Aug. 13, 2015

(30) Foreign Application Priority Data
Sep. 3, 2014 (CN) 201410445400.3

(51) Int. Cl. G02F 1/1333; G06F 3/041; G02F 1/1362; G02F 1/133; G02F 1/1335

(52) U.S. Cl. CPC G02F 1/13338; G02F 1/13306; G02F 1/133512; G02F 1/133516; G02F 1/136286; G06F 3/0412; G02F 1/133514; G02F 1/133528

(57) ABSTRACT

The present invention provides a color film substrate, comprising a base plate and a black matrix on the base plate, wherein the black matrix comprises a plurality of first black matrix strips in a first direction and a plurality of second black matrix strips in a second direction, the first direction is perpendicular to the second direction, and at least one of the first black matrix strips are conductive to act as sense lines or drive lines during touching. The color film substrate can be fabricated by a process which is simple and has high yield. The present invention further provides a method for fabricating the color film substrate and a touch display device comprising the color film substrate.

### FIELD OF THE INVENTION

The present invention relates to the field of display technology, and particularly to a color film substrate, a method for fabricating the same, and a touch display device.

### BACKGROUND ART

A touch panel is an important carrier for integrating an input terminal and an output terminal, and is among the most simple, convenient, and natural computer-human interaction. Among various touch panels, a capacitive touch panel has become a popular touch panel due to its merits like high touch sensitivity and capability of multiple-point touch.

In the current capacitive touch panels, a projection-type and multiple-point capacitive touch technology is generally adopted. A touch functional layer for realizing the touch function comprises signal lines which lie in two layers and are perpendicular to each other. Signal lines in one layer are drive lines (Tx Lines), and signal lines in the other layer are sense lines (Rx Lines). The drive lines are driven in turn in a scanning manner. When one of the drive lines is driven, the sense lines intersecting this drive line are scanned one by one. In this way, it is determined the phenomenon of capacitive coupling occurs at a certain point, so that the exact touching point can be obtained to realize touch function.

According to the structure, the existing capacitive touch panels can generally be divided into GG (Glass-Glass), GF (Glass-Film), OGS (One Glass Solution), On Cell, In Cell, or the like.

However, since the glass plate in the OGS touch panel not only acts as a protection glass for the display panel, but also acts as a base plate for the touch functional layer, which poses strict requirement on strength of the OGS touch panel. Usually, after the touch functional layer is fabricated, the glass plate should be reinforced and then is cut. The process for cutting a reinforced glass plate is difficult and the cost is high. Capillary cracks tend to develop along edges of the glass plate, which reduce strength of the glass plate. Once fracture appears in the OGS touch panel, the touch function fails.

In an In Cell touch panel, a touch functional layer is embedded in the pixel structure, leading a complex process for fabricating the touch panel array substrate, and reducing yield of the touch panel.

### SUMMARY

To overcome defects in the prior art, the problem to be solved by the present invention is to provide a color film substrate, a method for fabricating the same, and a touch display device, which can decrease difficulty for fabricating the touch display device, simplify the fabricating process, and increase yield.

To this end, the following technical solutions are adopted in the present invention:

The present invention provides a color film substrate, comprising: a base plate; and a black matrix on the base plate, wherein the black matrix comprises a plurality of first black matrix strips in a first direction and a plurality of second black matrix strips in a second direction, the first direction is perpendicular to the second direction, and at least one of the first black matrix strips are conductive to act as sense lines or drive lines during touching.

Preferably, the conductive first black matrix strips are made from a metallic material.

Preferably, two neighboring conductive first black matrix strips are spaced by non-conductive first black matrix strips of an equal number.

Preferably, the conductive first black matrix strips are divided into a plurality of groups, each group comprises a plurality of the conductive first black matrix strips, the conductive first black matrix strips comprised in each group are of an equal number, and two neighboring groups of the conductive first black matrix strips are spaced by non-conductive first black matrix strips of an equal number.

The present invention further provides a method for fabricating a color film substrate, comprising a step of forming a black matrix on a base plate, wherein the black matrix comprises a plurality of first black matrix strips in a first direction and a plurality of second black matrix strips in a second direction, the first direction is perpendicular to the second direction, and at least one of the first black matrix strips are conductive to act as sense lines or drive lines during touching.

Preferably, the step of forming the black matrix on the base plate comprises:

forming the conductive first black matrix strips on the base plate; and

forming a first and second black matrix strip which are non-conductive on the base plate.

Preferably, the non-conductive first and second black matrix strip are formed prior to the time when the conductive first black matrix strips are formed, the non-conductive first and second black matrix strip are formed at the same time as when the conductive first black matrix strips are formed, or the non-conductive first and second black matrix strip are formed after the time when the conductive first black matrix strips are formed.

The present invention further provides a touch display device, comprising the color film substrate as described above; and an array substrate which is arranged opposite to the color film substrate, wherein the array substrate comprise plurality of data lines and plurality of gate lines.

Preferably, in case the conductive first black matrix strips act as sense lines during touching, at least one of the gate lines act as drive lines during touching; and in case the conductive first black matrix strips act as drive lines during touching, at least one of the gate lines or at least one of the data lines act as sense lines during touching.

In the color film substrate, the method for fabricating the same, and the touch display device of the present invention, at least one of the first black matrix strips in the first direction on the color film substrate are formed into conductive black matrix strips, so that these conductive black matrix strips can act as sense lines (or drive lines) during touching. Meanwhile, at least one of the gate lines (or data lines) of the array substrate in the touch display device correspondingly act as drive lines (sense lines) during touching In this manner, the touch function is realized. Both drive lines and sense lines for realizing the touch function are integrated in the display panel in the present embodiment. Thus, a light and thin device is realized. Besides, it is not necessary to form a touch functional layer on a substrate of a display panel. As a result, the problem of a difficult process with low yield due to the fact that the substrate of the display panel acts as both protection glass for the display panel and a base plate for the touch functional layer can be avoided.

Further, since gate lines of the array substrate of display device are multiplexed as drive lines during touching in the present embodiment (or gate lines/data lines are multiplexed as sense lines), it is not necessary to increase steps during fabricating the array substrate. The sense lines (or drive lines) are black matrix strips on the color film substrate. Therefore, during fabrication, it is only required to adopt a conductive material for forming black matrix strips which will act as sense lines, thus simplifying the process for fabricating the touch display device and improving the yield.

### BRIEF DESCRIPTION OF DRAWINGS

These and other aspects of the present invention will now be described in more detail, with reference to the appended drawings showing currently preferred embodiments of the present invention.

FIG. 1 is a plan view of a black matrix in a color film substrate according to an embodiment of the present invention;

FIG. 2 is a cross-sectional view of a touch display device according to an embodiment of the present invention; and

FIG. 3 is a plan view of conductive first black matrix strips and gate lines of a touch display device according to an embodiment of the present invention.

### DETAILED DESCRIPTION OF EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

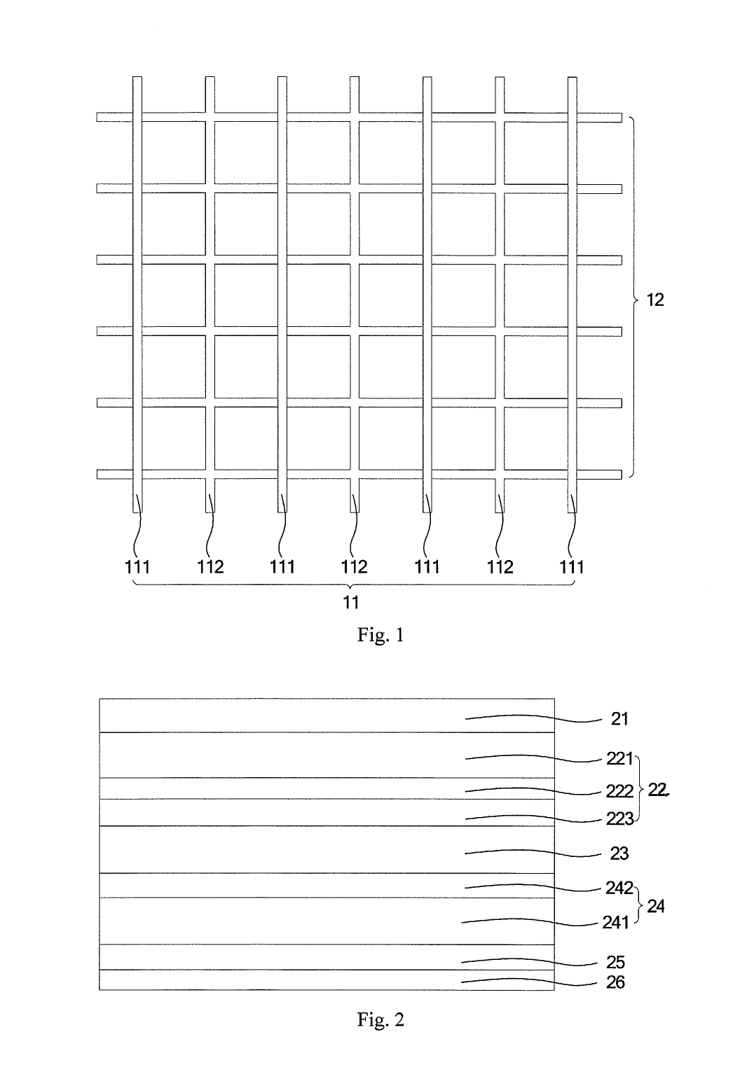

An embodiment of the present invention provides a color film substrate comprising a base plate; and a black matrix on the base plate. As shown in FIG. 1, the black matrix comprises a plurality of first black matrix strips 11 in a first direction and a plurality of second black matrix strips 12 in a second direction. The first direction is perpendicular to the second direction, and at least one of the first black matrix strips 11 are conductive to act as sense lines or drive lines during touching.

In the above color film substrate, at least one of the plurality of black matrix strips in a certain direction in the black matrix which previously acts as a light shielding part are made conductive. These black matrix strips not only shield light, but also are conductive to act as sense lines or drive lines during touching Thus, there is no need to additionally form sense lines or drive lines for touching As compared with the case in which all drive lines and sense lines are formed on an inner or outer side of the color film substrate, the present invention enables to simplify the process steps and device structure, thus improving yield of the color film substrate.

In addition, the black matrix strips which are already present on the color film substrate are multiplexed as sense lines or drive lines, so that it is not necessary to additionally to form a touch functional layer on the substrate of the display panel. As a result, it is avoided that the substrate of the display panel acts as both protection glass for the display panel and a base plate for the touch functional layer, in which case it is required to reinforce and cut the substrate. Therefore, the process difficulty can be decreased and the yield of the color film substrate can be improved.

Further, as for an In Cell touch panel in which all drive lines and sense lines of the touch functional layer are formed on the array substrate, the color film substrate of the present embodiment has a first black matrix strip which can act as a sense line or drive line, so that cross talk between sense lines or drive lines and some elements of the array substrate can be decreased to a certain extent, thus improving sensitivity of the touching function.

Further, in the present embodiment, the conductive first black matrix strips on the color film substrate can act as sense lines. Thus, as compared with the case of an In Cell touch panel, the sense lines are closer to a touching conductor like a finger, thus facilitating an improved touching sensitivity and responding speed.

It is noted that “first direction” preferably refers to a column direction, and “second direction” preferably refers to a row direction.

In the present embodiment, the conductive first black matrix strips 111 are made from a conductive material which can shield light. Preferably, the conductive material can be a metallic material like metal Mo, Cu, so that the black matrix not only has excellent light shielding property but also is conductive.

In case the plurality of first black matrix strips 11 further comprise non-conductive first black matrix strips 112, the non-conductive first black matrix strips 112 and the second black matrix strips 12 can preferably be formed by an insulating and light-shielding material like ink.

In the present embodiment, the number of the conductive black matrix strips in the first black matrix strip 12 and their distribution on the base plate are not restricted in any manner, and preferably can be determined on basis of requirements for touch accuracy. The number of conductive black matrix strips and a distributing density thereof can be increased in case higher touch accuracy is needed. The number of conductive black matrix strips and the distributing density thereof can be decreased in case there are no strict requirements for touch accuracy. Further, according to different requirements for touch accuracy in different regions, the number of conductive black matrix strips and distribution on the base plate can be designed on a basis of sub-regions. For example, since touch operations are generally concentrated on the central region of the display, as compared with the peripheral region, more conductive black matrix strips are arranged on the central region and a distributing density thereof is accordingly higher.

In particular, all of the first black matrix strips 11 can be formed to be conductive. Alternatively, a certain number of the black matrix strips can be formed to be conductive. Namely, the plurality of first black matrix strips 11 are divided into conductive first black matrix strips 111 and non-conductive first black matrix strips 112. In this case, two neighboring conductive first black matrix strips 111 can be spaced by non-conductive first black matrix strips 112 of an equal number. Alternatively, the conductive first black matrix strip can be divided into a plurality of groups, each group comprises a plurality of conductive first black matrix strips, the conductive first black matrix strips comprised in each group are of an equal number, and two neighboring groups are spaced by non-conductive first black matrix strips of an equal number, so that the touch function is improved in term of uniformity.

Corresponding to the above-mentioned color film substrate, the present embodiment provides a method for fabricating the above-mentioned color film substrate. The method comprises a step of forming a black matrix on a base plate, wherein the black matrix comprises a plurality of first black matrix strips in a first direction and a plurality of second black matrix strips in a second direction, the first direction is perpendicular to the second direction, and at least one of the first black matrix strips are conductive to act as sense lines or drive lines during touching.

In the above method, it is only required to adopt a conductive material for forming black matrix strips which will act as sense lines. Thus, there is no need to additionally form sense lines or drive lines for touching. Besides, it is not required to reinforce and cut the substrate of the display panel, thus simplifying the fabricating process.

In case the plurality of first black matrix strips are divided into conductive first black matrix strips and non-conductive first black matrix strips, the step of forming the black matrix on the base plate can particularly comprise the following steps.

Step S1: conductive first black matrix strips are formed on the base plate.

In this step, a conductive material can be firstly formed on the base plate by spinning, depositing, or sputtering, and then subject to a patterning process. As a result, the conductive material is partially removed. The conductive material is maintained in regions where the conductive first black matrix strips will be formed, thus forming conductive first black matrix strips.

Step S2: non-conductive first and second black matrix strips are formed on the base plate.

In this step, an insulating material can firstly be formed on the base plate by spinning, depositing, or sputtering, and then subject to a patterning process. As a result, the insulating material is partially removed. The insulating material is maintained in regions where the non-conductive first and second black matrix strips will be formed, thus forming the non-conductive first and second black matrix strips.

It is noted that the sequence for the step of forming non-conductive first and second black matrix strips and the step of forming conductive first black matrix strips is not limited to the above disclosure.

The present embodiment further provides a touch display device. As shown in FIG. 2, the touch display device comprises the color film substrate 22 as mentioned above; and an array substrate 24 which is arranged opposite to the color film substrate 22, wherein the array substrate comprises a plurality of data lines and a plurality of gate lines. In case at least one of the first black matrix strips re conductive to act as sense lines during touching, at least one of the gate lines act as drive lines during touching. In case at least one of the first black matrix strips are conductive to act as drive lines during touching, at least one of the gate lines or at least one of the data lines act as sense lines during touching.

In the above structure, the original black matrix strips on the color film substrate acts as sense lines and gate lines (or data lines) on the array substrate act as drive lines, and vise versa. In this way, both the drive lines and the sense lines for realizing touching function are integrated inside the display device. Thus, a light and thin device is realized. Besides, it is not necessary to form drive lines and sense lines on the substrate of the display panel. As a result, the problem of a difficult process with low yield due to the fact that the substrate of the display panel acts as both protection glass for the display panel and a base plate for the touch functional layer can be avoided.

In addition, since gate lines are multiplexed as drive lines during touching (alternatively, gate lines or data lines are multiplexed as sense lines) in the present embodiment, it is not necessary to increase steps during fabricating the array substrate. The sense lines (or drive lines) are black matrix strips on the color film substrate. Therefore, during fabrication, it is only required to adopt a conductive material for forming black matrix strips which will act as sense lines (or drive lines), thus simplifying the process for fabricating the touch display device and improving the yield.

Further, as compared with an In Cell touch panel, the array substrate of the touch display device in the present embodiment only contains drive lines (or sense lines) for touching As a result, the array substrate has a more simple structure, cross talk between elements is reduced, and the sensitivity of the touching function is improved to a certain extent.

As for an On Cell touch panel (in which the touch functional layer is arranged between the glass plate of the display panel and a polaroid), it is required to additionally deposit ITO (Indium Tin Oxide) on a display substrate to form a touch functional layer. In this case, the load on the substrate is increased to a certain extent. In addition, the drive lines and sense lines are integrated on the same substrate, and are close to each other, thus adversely affecting sensitivity and responding speed of touching. In view of this, it is preferred in the present embodiment that the first black matrix strips act as sense line, and the gate lines act as drive lines. In this case, the sense lines are located on the color film substrate which is close to a touching conductor like a finger, and the drive lines are located on the array substrate which is far away from the touching conductor like the finger. A distance between sense lines and drive lines is larger than the structure in which sense lines and drive lines are integrated in the same substrate, so that the touch display device of the present invention has an improved touching sensitivity and responding speed.

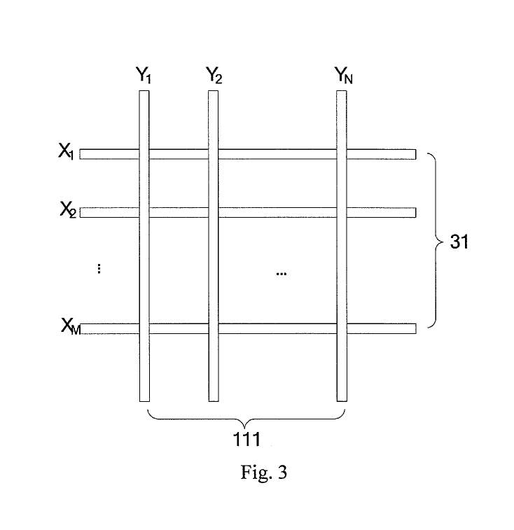

In the example of FIG. 3, conductive first black matrix strips 111 act as sense lines during touching and gate lines act as drive lines during touching. As shown by a plan view in FIG. 3, the gate lines 31 extend in the second direction, and are numbered as X₁, X₂, . . . , X_{M} from up to down. The conductive first black matrix strips 111 extend in the first direction, and are numbered as Y₁, Y₂, . . . , Y_{N} from left to right. The gate lines 31 intersect the conductive first black matrix strips 111 at points which have coordinates of [X_{M}, Y_{N}].

In the present embodiment, the gate lines 31 can be time division multiplexed for realizing the display and touch functions of the touch display device. Preferably, the time of a frame can be divided into a display scanning period and a touch scanning period. During the display scanning period, pixels are turned on, and gate lines 31 are scanned row by row to display a picture. During the touch scanning period, pixels are turned off, and gate lines 31 are multiplexed as drive lines for touching. The gate lines 31 are scanned row by row. When each gate line 31 is scanned, conductive first black matrix strips 111 are scanned column by column, so that conductive first black matrix strips 111 act as sense lines for touching. Sense signals in conductive first black matrix strips 111 are read, and it is determined whether the sense signals change. The change in the sense signals indicates a touch action, and coordinates of the point where the sense signals change are acquired. The acquired coordinates indicate the touch points.

It is noted that the above driving process is described in a case in which the first black matrix strips are divided into conductive first black matrix strips and non-conductive first black matrix strips, and two neighboring conductive first black matrix strips 111 are spaced by non-conductive first black matrix strips 112 of an equal number. In a case in which the first black matrix strip are divided into conductive first black matrix strips and non-conductive first black matrix strips, the conductive first black matrix strips are divided into a plurality of groups, each group comprises a plurality of conductive first black matrix strips, the conductive first black matrix strips comprised in each group are of an equal number, and two neighboring groups are spaced by non-conductive first black matrix strips of an equal number, the driving process is similar to the case as described above. Instead of scanning conductive first black matrix strips column by column in the above case, conductive first black matrix strips are scanned group by group, and the first black matrix strips in the same group can be scanned simultaneously, so that touch accuracy can be improved.

Besides, all gate lines 31 can be multiplexed during driving as drive lines for touching. Alternatively, a certain number of gate lines 31 are multiplexed as drive lines for touching. The gate lines 31 which act as drive lines for touching can preferably be uniformly distributed on the base plate of the array substrate, so that the touch function is improved in term of uniformity.

The general structure of the touch display device in the present embodiment is described in details by referring to FIG. 2. The color film substrate 22 of the touch display device comprises: a base plate 221; a black matrix 222 formed on the base plate 221; and a color resist 223 formed in grid regions determined by the black matrix 222.

The array substrate 24 comprises a glass plate 241, and a TFT (Thin Film Transistor) array 242 formed on the glass plate 241.

The touch display device further comprises: a liquid crystal layer 23 between the color film substrate 22 and the array substrate 24; a first polaroid 21 on a side of the color film substrate 22 which is away from the liquid crystal layer; a second polaroid 25 on a side of the array substrate 24 which is away from the liquid crystal layer; and a back light module 26 on a side of the second polaroid 25 which is away from the liquid crystal layer.

It is noted that, the structure of the touch display device in the present embodiment is described by taking a liquid crystal display device with the above structure. In other embodiments of the present invention, the touch display device based on the inventive concept of the present invention can further be any product or component like OLED (Organic Light-Emitting Diode) panel, mobile phone, tablet computer, TV set, monitor, notebook computer, digital photo frame, and navigator.

Although the present invention has been described above with reference to specific embodiments, it should be understood that the limitations of the described embodiments are merely for illustrative purpose and by no means limiting. Instead, the scope of the disclosure is defined by the appended claims rather than by the description, and all variations that fall within the range of the claims are intended to be embraced therein. Thus, other embodiments than the specific ones described above are equally possible within the scope of these appended claims.

What is claimed is:

1. A color film substrate, comprising:
a base plate; and
a black matrix on the base plate, wherein the black matrix comprises a plurality of first black matrix strips in a first direction and a plurality of second black matrix strips in a second direction, the first direction is perpendicular to the second direction, and at least one of the first black matrix strips are conductive to act as sense lines or drive lines during touching.

2. The color film substrate of claim 1, wherein the conductive first black matrix strips are made from a metallic material.

3. The color film substrate of claim 1, wherein two neighboring conductive first black matrix strips are separated by non-conductive first black matrix strips of an equal number.

4. The color film substrate of claim 1, wherein the conductive first black matrix strips are divided into a plurality of groups, each group comprises a plurality of the conductive first black matrix strips, the conductive first black matrix strips in each group are of an equal number, and two neighboring groups of the conductive first black matrix strips are separated by non-conductive first black matrix strips of an equal number.

5. A method for fabricating a color film substrate, comprising:
forming a black matrix on a base plate, wherein the black matrix comprises a plurality of first black matrix strips in a first direction and a plurality of second black matrix strips in a second direction, the first direction is perpendicular to the second direction, and at least one of the first black matrix strips are conductive to act as sense lines or drive lines during touching.

6. The method of claim 5, wherein the step of forming the black matrix on the base plate comprises:
forming the conductive first black matrix strips on the base plate; and
forming a first and second black matrix strip which are non-conductive on the base plate.

7. The method of claim 6, wherein the non-conductive first and second black matrix strip are formed prior to forming the conductive first black matrix strips on the base plate.

8. The method of claim 6, wherein forming the non-conductive first and second black matrix strip is done at the same time as forming the conductive first black matrix strips.

9. The method of claim 6, wherein forming the non-conductive first and second black matrix strip is done forming the conductive first black matrix strips.

10. A touch display device, comprising:
the a color film substrate comprising:
a base plate; and
a black matrix on the base plate, wherein the black matrix comprises a plurality of first black matrix strips in a first direction and a plurality of second black matrix strips in a second direction, the first direction is perpendicular to the second direction, and at least one of the first black matrix strips are conductive to act as sense lines or drive lines during touching; and
an array substrate which is arranged opposite to the color film substrate, wherein the array substrate comprises a plurality of data lines and a plurality of gate lines.

11. The touch display device of claim 10, wherein when the conductive first black matrix strips act as sense lines during touching, at least one of the gate lines act as drive lines.

12. The touch display device of claim 10, wherein when the conductive first black matrix strips act as drive lines during touching, at least one of the gate lines or at least one of the data lines act as sense lines.
